(19) United States
(12) Patent Application Publication
(10) Pub. No.: US 2007/0094513 A1
(43) Pub. Date: Apr. 26, 2007

(54) Data unit protecting method and system

(75) Inventor: Sheng-Hsiung Hu, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/258,233

(22) Filed: Oct. 26, 2005

(51) Int. Cl. H04L 9/00; G06F 12/14; H04L 9/32; G06F 11/30

(52) U.S. Cl. 713/193; 713/165; 713/167

(57) ABSTRACT

A data protecting system includes a storage device for storing a data unit having an index data and a content data, an input interface for inputting a specific set of codes, an encryption module for encrypting position of an initial cluster of the content data and saving the same in the index data and a central processing unit for processing the position of the initial cluster and the specific set of codes and later storing the position of the initial cluster and the specific set of codes within the index data after completing encrypting operation thereof.

### FIELD OF THE INVENTION

The present invention relates to a protecting method and system, more particularly to a data unit protecting method and system that is adapted to prevent an unauthorized person from entering and fetching the data.

### BACKGROUND OF THE INVENTION

Traditionally, an operation system (such as Microsoft Windows) is generally used for protecting the data unit in the hard disk. It is noted that for those files saved within a computer in FAT16, FAT32 file systems are accessible by any person under the Microsoft Windows using the same computer. In other words, any unauthorized person can access the files stored in FAT16, FAT32 file systems. In case the file is saved within the computer under NTFS file system, though the later system is compatible with different operation system, the file can be arranged in such a manner to be protected from access by an unauthorized person.

FIG. 1 is a block diagram illustrating a conventional data protecting method. As shown, the computer includes an operation system 15 (Windows XP), and a system disk 15, whereas the file 13 is saved within the system disk 15 under the NTFS file system 11. The system disk 15 and the NTFS file system 11 can be located within the same or different hard disk. In the event, the user 14 of the computer set up a set of authorized codes via the Windows XP for access to the file 13 within the computer and the set of authorized codes is later saved within the system disk 12. When the user 14 boots the computer up under the Windows XP for access the file 13, he is granted access to the file only once the correct number or the set of authorized codes is inputted into the computer.

Referring to FIG. 2, a hacker 16 wishes to access the file 13 saved within the system disk 12 under the NTFS file system 11 by using the other operation system and a disk edit tool 18 (such as Acronis disk editor). In such a case, the hacker 16 is unable to access the file 13 since the driver for driving the system disk 12 is not activated. Under such condition, the computer will neither request the hacker to input his or her identification. The reason simply resides in that the set of authorized codes for accessing the file is saved within the system disk 12. Any person booting the computer up without using the system disk 12 is denied access to the file 13.

In addition, each file includes an initial cluster. According to the conventional protecting method, the position of the initial cluster is not encrypted so that the hacker 16 is adapted to access easily the file saved in the computer by using the disk edit tool. Moreover, the conventional protecting method is suitable for those files saved under NTFS file system. The conventional protecting method is incompatible for those files saved under FAT16, FAT32 file systems.

### SUMMARY OF THE INVENTION

The object of the present invention is to provide a data unit protecting method and system that is adapted to prevent an unauthorized person from entering and fetching the data.

In one aspect of the present invention, a method is proposed for protecting a data unit that is stored within a storage device and that includes an index data and a content data, the content data having an initial cluster stored within the index data. The data unit protecting method includes: encrypting position of the initial cluster of the content data; setting up a specific set of codes for decrypting the position of the initial cluster stored within the index data; and storing the specific set of codes within the index data.

In another aspect of the present invention, a system is proposed for protecting a data unit, the data unit including an index data and a content data, the content data having an initial cluster stored within the index data. The data protecting system includes: a storage device for storing the data unit therein; an input interface for inputting a specific set of codes; an encryption module for encrypting position of the initial cluster of the content data and the specific set of codes; and a central processing unit for processing the position of the initial cluster of the content data and the specific set of codes and later storing the position of the initial cluster and the specific set of codes within the index data after completing encrypting operation thereof.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a block diagram illustrating how a user access a file according to a conventional method;

FIG. 2 is a block diagram illustrating how a user access a file according to anther conventional method;

FIG. 3 is a block diagram illustrating how index and content data of a file is saved within a computer according to the data protecting method of the present invention;

FIG. 3 is a block diagram illustrating how index and content data of a file is saved within a computer according to the data protecting method of the present invention;

FIGS. 4A and 4B respectively illustrates the steps during access to a file according the data protecting method of the present invention; and

FIG. 5 is a block diagram illustrating how index and content data of a file is saved within a computer according to the data protecting method of the present invention;

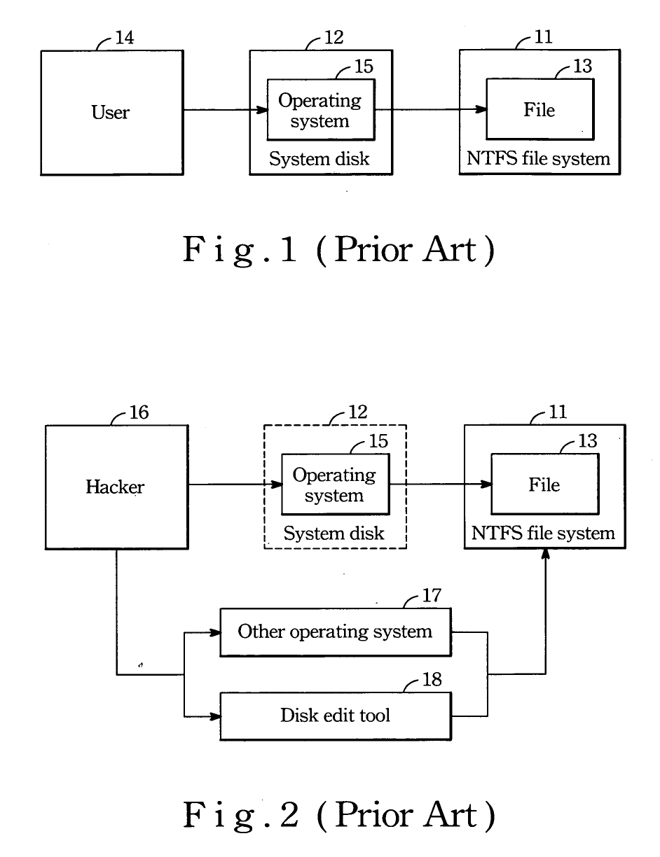

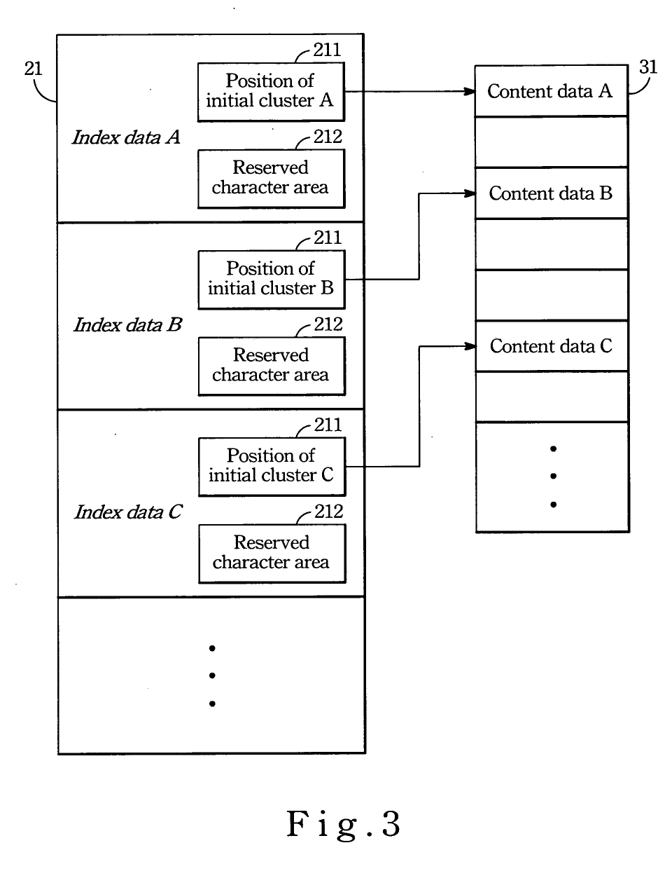

### DETAILED DESCRIPTIONS OF THE PREFERRED EMBODIMENT

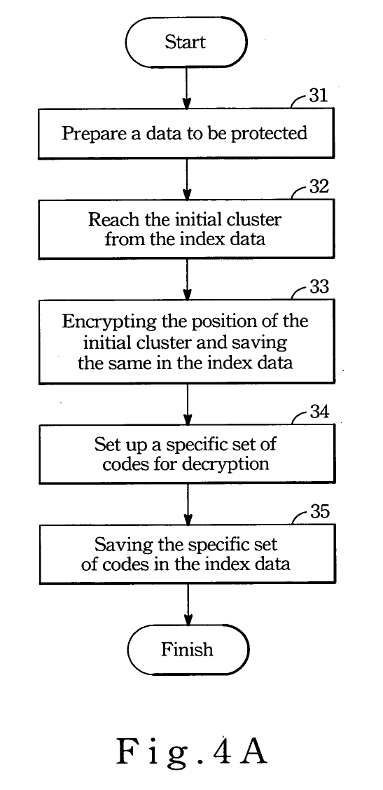

FIG. 3 is a block diagram representing a storage structure of a file saved within a storage device of a computer that is protected by the data unit protecting method of the present invention. The storage device can be a built-in hard disk or an externally connected hard disk or any other hard disk so long as it can save data therein. The file is preferably written and saved in the FAT 16 file system, and includes an index data 21 and a content data 31. The index data 21 includes a FDB (file description block) of 32 bytes size, in which, a main file name, an extension name, type of the file, access date, date of storage, set-up time of the file, size of the file, and an initial cluster 211 of the content data 31. The FDB further includes at least one a reserved character area 212. The position of the initial cluster 211 is formed by a group of numbers having 16 digits written in binary number system. In addition to the aforesaid file system or a minor index, FAT32 or NTFS file system and other operation system (such as LINUX, UNIX, S/O, MACOS) can be saved within the storage structure.

Referring to FIG. 3 again, in case the user wishes to access an unprotected file A, the operation system will firstly check and detect the position of the initial cluster 211 of the content data A saved in the index data A. The user is permitted access to the unprotected file A once the initial cluster 211 is found within the index data 21. According to the data protecting method of the present invention, the position of the initial cluster 211 of the content data is encrypted in order to prevent the hacker from access the initial cluster (hence the content data) by using other operation system or the disk edit tool. To achieve the file protecting purpose, a specific set of codes is setup for decrypting the position of the initial cluster 211 and is saved within the reserved character area 212 of the index data 21 so as to deny the hacker from accessing the file A who uses the disk edit tool. The hacker is unable to access the file A without the proper number to restore the initial cluster back into the content data, since he cannot locate the position of the initial cluster.

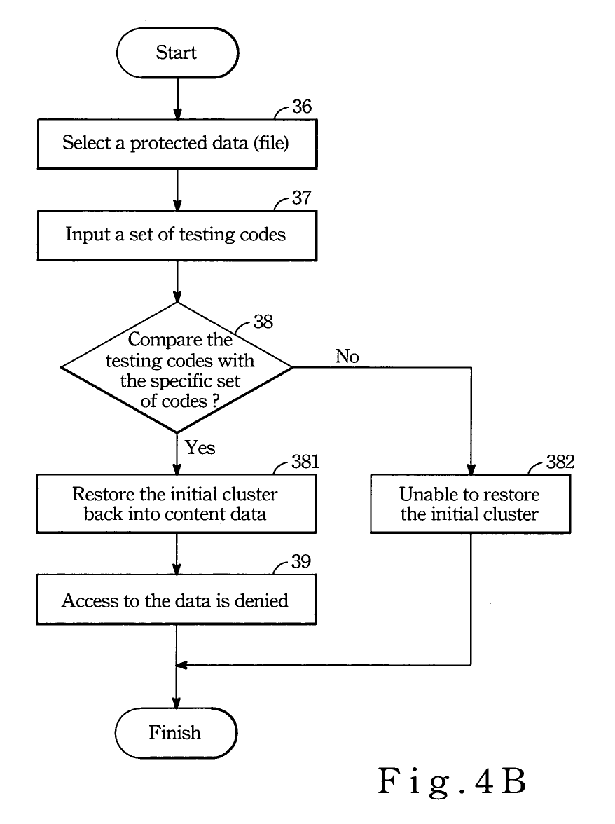

FIG. 4A illustrates the steps of data unit protecting method according to the present invention. The method includes the step (31) the user prepares a file to be protected as shown in FIG. 3; wherein the file includes an index data and a content data. According to the step (32) the initial cluster of the content data is taken from the index data. The position of the initial cluster is encrypted and is later saved in the index data according to the step (33). In the steps (34) and (35): a specific set of codes is set up and is saved within the reserved character area of the index data for decrypting the position of the initial cluster during access to the content data. In the aforesaid steps, encryption of the position of the initial cluster and setting up of the specific set of codes can be reversed. Alternately, the same specific set of codes can be used for encryption and decryption of the initial cluster. Preferably, some encryption method having public authentication can be employed for setting up of the specific set of codes. The user can use numeral number, characters, symbols, a combination of characters and numbers, a combination of characters and symbols, a combination of numbers and symbols or any other group consisting numbers, symbols and character. The aforesaid specific set of codes can be written in the form of software program and is latter saved in the Windows, BSD, UNIX, MACOS, OS/2 or LINUX operation system. The specific set of codes and the position of the initial cluster constant are saved within the index data and since the file is removable together with the storage device, an individual file is protected constantly by the protecting method of the present invention. In the prior method, some files are protected only under certain operation system. In contrast to the prior method, the file of the present invention can be disposed under constant protection within any available operation system according to the protecting method.

FIG. 4B is a block diagram illustrating the steps during access to the file protected according to the method of the present invention. In the step 36, the user wishes to access one of the files being protected by the method of the present invention. According to the step 37, the software may request the user to conduct a testing operation. The testing operation includes the steps 38: inputting a set of testing codes into the input interface of the computer and permitting the encryption module of the computer to compare the set of testing codes with respect to the specific set of codes. In case of a match between the testing codes and the specific set of codes, the position of the initial cluster 381 is decrypted by the module and is restored back into the content data of the file being accessed, thereby locating the initial cluster of the content data according to the step 39. Under this condition, the computer will permit the user gaining access to the selected file. In the event, the position of the initial cluster 382 saved within the index is unable to recover back to the content data due to lack of exact cluster position within the storage device, the user is prevented from gaining access to the selected file.

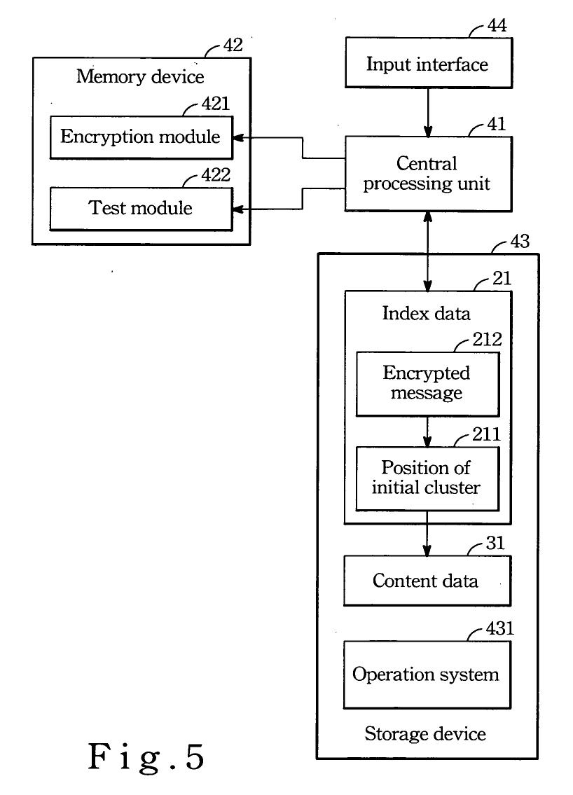

FIG. 5 is a block diagram representing the software and hardware structure employed in the data unit protecting system of the present invention. The protecting system includes a storage device 43, a central processing unit 41, an input interface 44, and a memory device 42. The storage device 43 is used for storing data, such as an operation system 431, and a file consisting of a content data 31 and an index data 21, where an encrypted message 212 and the position of the initial cluster 211 are kept. The memory device 42 includes an encryption module 421 for encrypting the position of the initial cluster of the content data 31 prior to saving the encrypted message 212 within the storage device 43. The input interface 44 is used for inputting the specific set of codes for decryption of the position of the initial cluster 211. The central processing unit 41 is used for processing the initial cluster 211 and the specific set of codes prior to saving the same within the index data 21. Note that during the processing operation of the initial cluster and the specific set of codes by the central processing unit, the former two are temporarily kept in the memory device 42. When the user wishes to access the file protected by the system of the present invention, the user is requested to input the set of testing codes via the input interface 44, where the set of testing codes is temporarily kept in the memory device 42 to permit the test module 422 to conduct the comparison operation with respect to the specific set of codes by assistance of the central processing unit 41. In case of coincidence occurs between the testing codes and the specific set of codes, the position of the initial cluster saved in the index data is restored back to the content data, thereby granting the user access to the protected file.

In summary, the data protecting method and system of the present invention provides the following advantages over the conventional techniques:

(1) The encrypted position of the initial cluster is saved the index data and since the former two are removable together with the storage device, the individual file is disposed under constant protection;

(2) The file is not protected by any specific operation system so that change of operation system from one to anther will not affect the protection of the file;

(3) In case the method of the present invention is executed to protect a file under a utility program, the latter may deny other person from accessing the file.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method for protecting a data unit that is stored within a storage device and that includes an index data and a content data, the content data having an initial cluster stored within the index data, the data unit protecting method comprising:
encrypting position of the initial cluster of the content data;
setting up a specific set of codes for decrypting the position of the initial cluster stored within the index data; and
storing said specific set of codes within the index data.

2. The data unit protecting method according to claim 1, further comprising a testing operation, the testing operation including step (a): inputting a set of testing codes, and step (b): comparing said set of testing codes with said specific set of codes, whereby, said position of said initial cluster is decrypted once said set of testing codes matches with said specific set of codes, thereby permitting access into the content data and vice versa.

3. The data unit protecting method according to claim 1, wherein the index data includes at least a reserved character area, said specific set of codes being stored within said reserved character area.

4. The data unit protecting method according to claim 1, wherein the position of the initial cluster of the content data and said specific set of codes for decrypting the position of the initial cluster are stored temporarily within a memory device to permit encrypting operation by a central processing unit prior to being stored within the index data.

5. The data unit protecting method according to claim 1, wherein the data unit protecting method is a software program that is adapted to be stored within a memory device.

6. The data unit protecting method according to claim 2, wherein the data unit protecting method is software program that is adapted to be stored within a memory device.

7. The data unit protecting method according to claim 1, wherein the storage device is a hard disk.

8. The data unit protecting method according to claim 1, wherein the data unit is a file or document.

9. A system for protecting a data unit, the data unit including an index data and a content data, the content data having an initial cluster stored within the index data, the protecting system comprising:
a storage device for storing the data unit therein;
an input interface for inputting a specific set of codes;
an encryption module for encrypting position of the initial cluster of the content data and said specific set of codes; and
a central processing unit for processing the initial cluster of the content data and said specific set of codes and later storing said position of the initial cluster and said specific set of codes within the index data after completing encrypting operation thereof.

10. The protecting system according to claim 9, further comprising a test module, said input interface capable of receiving a set of testing codes, said test module capable of comparing said set of testing codes with said specific set of codes, whereby, said position of said initial cluster is decrypted once said set of testing codes matches with said specific set of codes, thereby permitting access into the content data and vice versa.

11. The protecting system according to claim 9, wherein the index data includes at least a reserved character area, said specific set of codes being stored within said reserved character area.

12. The protecting system according to claim 9, wherein said encryption module is capable of providing an encryption computing power to permit said central processing unit to conduct said encrypting operation onto the position of the initial cluster and said specific set of codes.

13. The protecting system according to claim 9, wherein said encryption module is software program that is adapted to be stored within a memory device.

14. The protecting system according to claim 10, wherein
said encryption module is software program that is adapted to be stored within a memory device.

15. The protecting system according to claim 9, wherein said storage device is a hard disk.

16. The protecting system according to claim 9, wherein the data unit is a file or document.
